(19) United States
(12) Patent Application Publication
(10) Pub. No.: US 2026/0319328 A1
(43) Pub. Date: Oct. 15, 2026

(54) DUAL-APERTURE ZOOM DIGITAL CAMERA WITH AUTOMATIC ADJUSTABLE TELE FIELD OF VIEW

(71) Applicant: Corephotonics Ltd., Tel Aviv (IL)

(72) Inventors: Gal Shabtay, Tel Aviv (IL); Ephraim Goldenberg, Tel Aviv (IL); Eran Kali, Tel Aviv (IL); Noy Cohen, Tel Aviv (IL); Gil Avraham, Tel Aviv (IL); Ruthy Katz, Tel Aviv (IL)

(21) Appl. No.: 19/643,848

(22) Filed: Apr. 10, 2026

Related U.S. Application Data
(63) Continuation of application No. 18/335,192, filed on Jun. 15, 2023, now Pat. No. 12,619,126.
Application No. 18/335,192 is a continuation of application No. 17/882,640, filed on Aug. 8, 2022, now Pat. No. 11,726,388.
Application No. 17/882,640 is a continuation of application No. 17/846,203, filed on Jun. 22, 2022, now Pat. No. 11,599,007.
Application No. 17/846,203 is a continuation of application No. 17/145,309, filed on Jan. 9, 2021, now Pat. No. 11,392,009.
Application No. 17/145,309 is a continuation of application No. 16/699,577, filed on Nov. 30, 2019, now Pat. No. 10,935,870.
Application No. 16/699,577 is a continuation of application No. 15/525,059, filed on Dec. 5, 2016, now Pat. No. 10,578,948.
(60) Provisional application No. 62/272,367, filed on Dec. 29, 2015.
(60) Provisional application No. 62/361,150, filed on Jul. 12, 2016.

(51) Int. Cl. G03B 3/06; G02B 13/06; G02B 26/10; G03B 17/17; H04N 3/08; H04N 23/45; H04N 23/55; H04N 23/58; H04N 23/63; H04N 23/67; H04N 23/69; H04N 23/90; H04N 23/951

(52) U.S. Cl. CPC G03B 3/06; G02B 26/105; G03B 17/17; H04N 3/08; H04N 23/45; H04N 23/55; H04N 23/58; H04N 23/63; H04N 23/631; H04N 23/69; H04N 23/90; H04N 23/951; G02B 13/06; G03B 2217/002; H04N 23/675

(57) ABSTRACT

Digital camera comprising an upright Wide camera configured to provide a Wide image with a Wide image resolution and a folded Tele camera configured to provide a Tele image with a Tele image resolution higher than the Wide image resolution, the Wide and Tele cameras having respective Wide and Tele fields of view FOV_{W} and FOV_{T} and respective Wide and Tele image sensors, the digital camera further comprising a rotating OPFE operative to provide a folded optical path between an object or scene and the Tele image sensor, wherein rotation of the OPFE moves FOV_{T} relative to FOV_{W}. In some embodiments, a rectangular FOV_{T} is orthogonal to a rectangular FOV_{W}. When included in a host device having a user interface that displays FOV_{T} within FOV_{W}, the user interface may be used to position FOV_{T} relative to FOV_{W}, scan FOV_{T} across FOV_{W} and acquire, store and display separate Wide and Tele images, composite Wide plus Tele images and stitched Tele images. The positioning of FOV_{T} within FOV_{W}, can be done automatically (autonomously) by continuously tracking an object of interest.

### CROSS REFERENCE TO RELATED APPLICATIONS

This application is a continuation of U.S. patent application Ser. No. 18,335,192 filed Jun. 15, 2023 (now allowed), which was a continuation of U.S. patent application Ser. No. 17,882,640 filed Aug. 8, 2022 (now U.S. Pat. No. 11,726,388), which was a continuation of U.S. patent application Ser No. 17,846,203 filed Jun. 22, 2022 (now U.S. Pat. No. 11,599,007), which was a continuation of U.S. patent application Ser. No. 17/145,309 filed Jan. 9, 2021 (now U.S. Pat. No. 11,392,009), which was a continuation of U.S. patent application Ser. No. 16/699,577 filed Nov. 30, 2019 (now U.S. Pat. No. 10,935,870), which was a continuation of U.S. patent application Ser. No. 15/525,059 filed May 6, 2017 (now U.S. Pat. No. 10,578,948), which was a 371 application from international patent application PCT/IB2016/057366 filed Dec. 5, 2016 and claims priority from US Provisional Patent Applications No. 62/272,367 filed on Dec. 29, 2015 and 62/361,150 filed on Jul. 12, 2016, both of which are expressly incorporated herein by reference in their entirety.

### FIELD

Embodiments disclosed herein relate in general to digital cameras and in particular to thin zoom digital cameras.

### BACKGROUND

Host devices or “personal computing and/or communication devices” (such as smartphones) having two back cameras (also referred to as “dual-camera” or “dual-aperture camera”) are known, see e.g. U.S. Pat. No. 9,185,291. The two back cameras have two image sensors (or simply “sensors”) operated simultaneously to capture an image, and have lenses with different focal lengths. Even though each lens/sensor combination is aligned to look in the same direction, each will capture an image of the same scene but with two different fields of view (FOV).

Dual-aperture zoom cameras in which one camera has a “Wide” FOV (FOV_{W}) and the other has a narrow or “Tele” FOV (FOV_{T}) are also known, see e.g. U.S. Pat. No. 9,185,291. The cameras are referred to respectively as Wide and Tele cameras that include respective Wide and Tele sensors. These sensors provide respectively separate Wide and Tele images. The Wide image captures FOV_{W} and has lower spatial resolution than the Tele image that captures FOV_{T}. As used herein, “FOV” is defined by the tangent of the angle between a line crossing the lens and parallel to the lens optical axes and a line between the lens and any object that is captured on the respective image corner. The images may be merged (fused) together to form a composite image. In the composite image, the central portion is formed by combining the relatively higher spatial resolution image taken by the lens/sensor combination with the longer focal length, and the peripheral portion is formed by a peripheral portion of the relatively lower spatial resolution image taken by the lens/sensor combination with the shorter focal length. The user selects a desired amount of zoom and the composite image is used to interpolate values from the chosen amount of zoom to provide a respective zoom image. Hereinafter, the use of “resolution” in this description refers to image spatial resolution, which is indicative to the resolving power of a camera as determined by the lens focal length, its aperture diameter and the sensor pixel size.

Dual-aperture cameras in which one image (normally the Tele image) is obtained through a folded optical path are known, see e.g. co-invented and co-owned U.S. patent application Ser. No. 14/455,906, which teaches zoom digital cameras comprising an “upright” (with a direct optical axis to an object or scene) Wide camera and a “folded” Tele camera, see also FIG. 2B below. The folded camera has an optical axis substantially perpendicular (orthogonal) to an optical axis of the upright camera. The folded Tele camera may be auto-focused and optically stabilized by moving either its lens or by tilting an optical path folding (reflecting) element (e.g. a prism or mirror and referred to also as “OPFE”) inserted in an optical path between its lens and a respective sensor. For simplicity, the optical path folding element is referred to hereinafter in this description generically as “prism”, with the understanding that the term may refer to any other optical path folding (reflecting) element that can perform the function of folding an optical path as described herein.

For example, PCT patent application PCT/IB2016/056060 titled “Dual-aperture zoom digital camera user interface” discloses a user interface for operating a dual-aperture digital camera included in host device, the dual-aperture digital camera including a Wide camera and a Tele camera, the user interface comprising a screen configured to display at least one icon and an image of a scene acquired with at least one of the Tele and Wide cameras, a frame defining FOV_{T} superposed on a Wide image defined by FOV_{W}, and means to switch the screen from displaying the Wide image to displaying the Tele image. The user interface further comprises means to switch the screen from displaying the Tele image to displaying the Wide image. The user interface may further comprise means to acquire the Tele image, means to store and display the acquired Tele image, means to acquire simultaneously the Wide image and the Tele image, means to store and display separately the Wide and Tele images, a focus indicator for the Tele image and a focus indicator for the Wide image.

Object recognition is known and describes the task of finding and identifying objects in an image or video sequence. Many approaches have been implemented for accomplishing this task in computer vision systems. Such approaches may rely on appearance based methods by using example images under varying conditions and large model-bases, and/or on feature based methods comprising of a search to find feasible matches between object features and image features, e.g., by using surface patches, corners and edges detection and matching. Recognized objects can be tracked in preview or video feeds using an algorithm for analyzing sequential frames and outputting the movement of targets between the frames.

The problem of motion-based object tracking can be divided into two parts:
(1) detecting moving objects in each frame. This can be done either by incorporating an object recognition algorithm for recognizing and tracking specific objects (e.g., human face) or, for example, by detecting any moving object in a scene. The latter may incorporate a background subtraction algorithm based on Gaussian mixture models with Morphological operations applied to the resulting foreground mask to eliminate noise. Blob analysis can later detect groups of connected pixels, which are likely to correspond to moving objects.
(2) associating the detections corresponding to the same object over time, e.g., using motion estimation filters such as the Kalman filter.

### SUMMARY

In exemplary embodiments, there are provided digital cameras comprising an upright Wide camera configured to provide a Wide image with a Wide image resolution, the Wide camera comprising a Wide image sensor and a Wide lens with a Wide field of view (FOV_{W}); a folded Tele camera configured to provide a Tele image with a Tele image resolution higher than the Wide image resolution, the Tele camera comprising a Tele image sensor and a Tele lens with a Tele field of view (FOV_{T}); and a rotating OPFE (e.g. prism) operative to provide a folded optical path between an object or scene and the Tele sensor, wherein rotation of the prism moves FOV_{T} relative to FOV_{W}.

In an embodiment, the Wide and Tele image sensors have a substantially rectangular shape defined by a respective height dimension and a respective width dimension and are in orthogonal planes and with their respective height dimensions orthogonal to each other such that FOV_{T} is rotated at 90 degrees to FOV_{W}.

In an embodiment, the movement of FOV_{T} relative to FOV_{W} is performed in a scanning mode that provides a plurality of partially-overlapping or adjacent non-overlapping Tele FOVs within FOV_{W}.

In an embodiment, the prism rotation has a range of up to ±15 degrees around a zero prism position in which FOV_{T} is centric to FOV_{W}.

In an embodiment, the digital camera may be included in a host device having a user interface for operating the digital camera, the user interface comprising a screen configured to display at least one icon and an image of the object or scene acquired with at least one of the Tele and Wide cameras and to display a frame defining FOV_{T} within FOV_{W}. The host device may have a user interface for operating the digital camera, the user interface comprising a screen configured to display at least one icon and an image of the object or scene acquired with at least one of the Tele and Wide cameras and to display a frame defining FOV_{T} within FOV_{W}. In an embodiment, the user interface may further comprise means for moving FOV_{T} relative to FOV_{W}. In an embodiment, the user interface may further comprise means for scanning FOV_{T} across FOV_{W}. In an embodiment, the user interface may further comprise means for switching the screen from displaying the Wide image to displaying the Tele image. In an embodiment, the user interface may further comprise means to acquire the Tele image. In an embodiment, the user interface may further comprise means to acquire simultaneously the Wide image and the Tele image.

In an embodiment, the user interface may further comprise means to automatically (autonomously) move the FOV_{T} relative to FOV_{W} to track object of interest. In such cases, the camera may also be referred to as an “autonomous” camera.

In an embodiment, the user interface may further comprise means to acquire video streams of the Wide and Tele camera simultaneously.

In an embodiment, Tele images representing are plurality of adjacent non-overlapping Tele FOVs are stitched together to form a stitched Tele image used in the fusion with the Wide image.

In an embodiment, at least one Tele image includes a plurality of consecutive Tele images stitched together to form a stitched Tele image used in a fusion procedure with the Wide image to provide a composite image.

In an embodiment, the Wide and Tele images or video streams can be fused (or combined or stitched) on the device or in a cloud environment (referred to simply as “cloud”).

In an embodiment, the digital camera is further configured to form a composite video stream in which each frame is based on either a processed Wide image or a processed Tele image, the processed Wide and Tele images acquired during the autonomous FOV_{T} tracking.

### BRIEF DESCRIPTION OF THE DRAWINGS

Non-limiting examples of embodiments disclosed herein are described below with reference to figures attached hereto that are listed following this paragraph. Identical structures, elements or parts that appear in more than one figure are generally labeled with a same numeral in all the figures in which they appear. The drawings and descriptions are meant to illuminate and clarify embodiments disclosed herein, and should not be considered limiting in any way.

FIG. 1A shows schematically an image reflecting the Wide FOV of a scene;

FIG. 1B shows schematically an image reflecting the Tele FOV of the scene in FIG. 1A;

FIG. 2A shows schematically a dual-aperture camera comprising a first upright camera and a second folded camera, with a prism folding an optical path to the folded camera in a zero position;

FIG. 2B shows a composite image obtained with a dual-aperture camera as in FIG. 2A, with the Tele FOV resulting from the zero position of the prism;

FIG. 3 shows schematically an arrangement enabling tilt of a prism in a folded optical path;

FIG. 4A shows schematically the dual-aperture camera of FIG. 2A with the prism rotated to a first position;

FIG. 4B shows a composite image obtained with a dual-aperture camera as in FIG. 4A, with the Tele FOV resulting from the first prism position;

FIG. 5A shows schematically the dual-aperture camera of FIG. 2A with the prism rotated to a second position;

FIG. 5B shows a composite image obtained with a dual-aperture camera as in FIG. 5A, with the Tele FOV resulting from the second prism position;

FIG. 6A shows schematically a dual-aperture camera comprising a first upright camera with a sensor rotated by 90 degrees relative to that in the camera of FIG. 2A and with a prism folding an optical path to a folded camera in a zero position;

FIG. 6B shows a composite image obtained with a dual-aperture camera as in FIG. 6A, with the Tele FOV resulting from the zero position of the prism;

FIG. 7A shows schematically the dual-aperture camera of FIG. 6A with the prism rotated to a first position;

FIG. 7B shows a composite image obtained with a dual-aperture camera as in FIG. 7A, with the Tele FOV resulting from the first prism position;

FIG. 8A shows schematically the dual-aperture camera of FIG. 6A with the prism rotated to a second position;

FIG. 8B shows a composite image obtained with a dual-aperture camera as in FIG. 8A, with the Tele FOV resulting from the second prism position;

FIG. 9A shows a smartphone and user interface incorporating a dual-aperture camera with Tele FOV positioning capability disclosed herein in a zero, centered position on the smartphone screen;

FIG. 9B shows the smartphone and user interface of FIG. 9A with the Tele FOV moved to a down position within the screen;

FIG. 9C shows the smartphone and user interface of FIG. 9A with the Tele FOV moved to an up position within the screen;

FIG. 9D shows the smartphone and user interface of FIG. 9A with the Tele FOV rotated by 90 degrees relative to the Wide FOV and moved to a right position within the screen;

FIG. 9E shows the smartphone and user interface of FIG. 9A with the Tele FOV rotated by 90 degrees relative to the Wide FOV and moved to a left position within the screen;

FIG. 10 shows a smartphone and user interface as in FIG. 9D or 9E used in a scanning mode of the Tele FOV.

FIG. 11A shows a smartphone and user interface incorporating a dual-aperture camera with automatic Tele FOV tracking disclosed herein with a first Tele FOV position on the smartphone screen;

FIG. 11B shows the smartphone and user interface of FIG. 11A with a second Tele FOV position on the smartphone screen;

FIG. 11C shows the smartphone and user interface of FIG. 11A with a third Tele FOV position on the smartphone screen.

### DETAILED DESCRIPTION

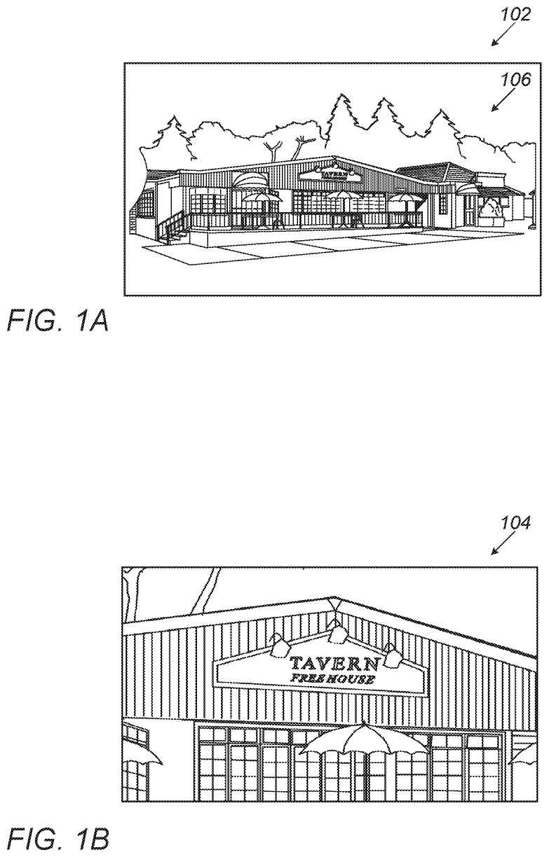

FIG. 1A shows schematically an image (or frame of a video stream) 102 reflecting the Wide FOV of a scene 106. FIG. 1B shows schematically an image (or frame of a video stream) 104 reflecting the Tele FOV of scene 106. Only part of the scene of FIG. 1A is seen in FIG. 1B. The two images or video streams are obtained simultaneously with a dual-aperture camera having an upright Wide camera and a folded Tele camera of the type for example disclosed in U.S. patent application Ser. No. 14/455,906. The two cameras may, for example, be two back cameras included in a smartphone or in another personal communication device.

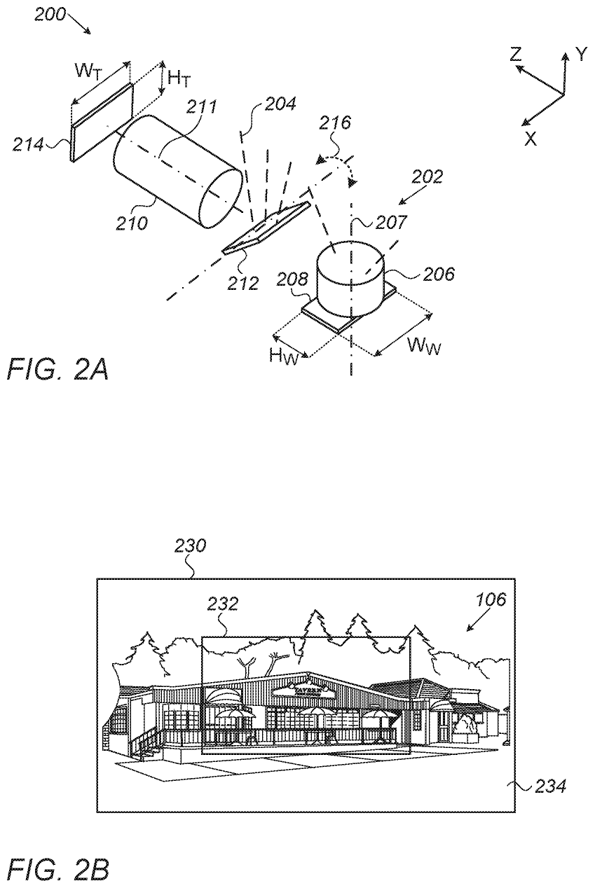

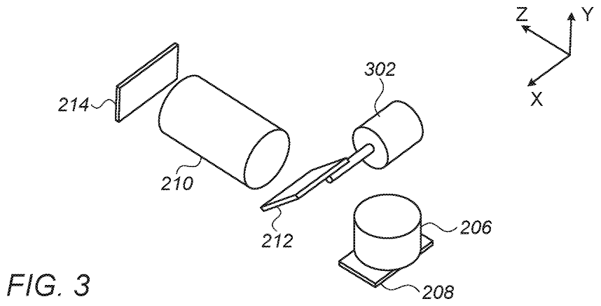

FIG. 2A shows schematically a dual-aperture camera 200 comprising a first upright camera 202 and a second folded camera 204. An XYZ coordinate system as shown is used in the description of this and all following “camera” drawings. For example, upright camera 202 is a Wide camera that includes a Wide lens assembly (or simply “lens”) 206 with an optical axis 207, and a Wide sensor 208. For example, folded camera 204 is a Tele camera that includes a Tele lens 210 with an optical axis 211, and a Tele sensor 214. An OPFE (e.g. prism) 212 may be part of the folded Tele camera or may be a separate element that folds an optical path parallel to axis 207 into an optical path parallel to axis 211 into the Tele lens. The Wide and Tele sensors lie in respective orthogonal planes, respectively the XZ plane and the XY plane. For example, the Wide and Tele sensors are substantially rectangular with respective height (H) and width (W) dimensions. Thus, Wide sensor 208 has a height H_{W} and a width W_{W} and Tele sensor 214 has a height H_{T} and a width W_{T}. The H/W ratio in both sensors is typically (although not necessarily) 9/16 or ¾. In the folded camera, positioning of sensor 214 with its height in the Y direction is advantageous in that it allows a smaller host device (e.g. a smartphone) thickness. In camera 200 in FIG. 2A (as well as cameras 200 in FIGS. 3, 4A and 5A), the width dimensions of sensors 208 and 214 are parallel to each other and to the X-axis.

The operation of a camera such as camera 200 is described in more detail in U.S. patent application Ser. No. 14/455,906. In particular, the prism can perform a tilt (rotation) movement 216 around the X-axis as shown. The rotation motion may be caused by a stepping motor 302 shown schematically in FIG. 3. The prism rotation angle may range between '115 degrees and +15 degrees around a “zero” position (see below), corresponding to ±30 degrees FOV_{T} shift. Cameras 202 and 204 are used for example to take respectively the Wide and Tele images of FIGS. 1A and 1B.

FIG. 2B shows an image 230 identical with Wide image 102 with a frame 232 that indicates the position of the Tele image FOV. The camera can have high resolution in this framed FOV either by fusing the Wide and Tele images or by capturing and saving the Tele image. For reference purposes, the position of the prism that causes the Tele FOV and resulting image to be centric to the Wide FOV and Wide image is called here for example and in a non-limiting way a “zero” position of the prism.

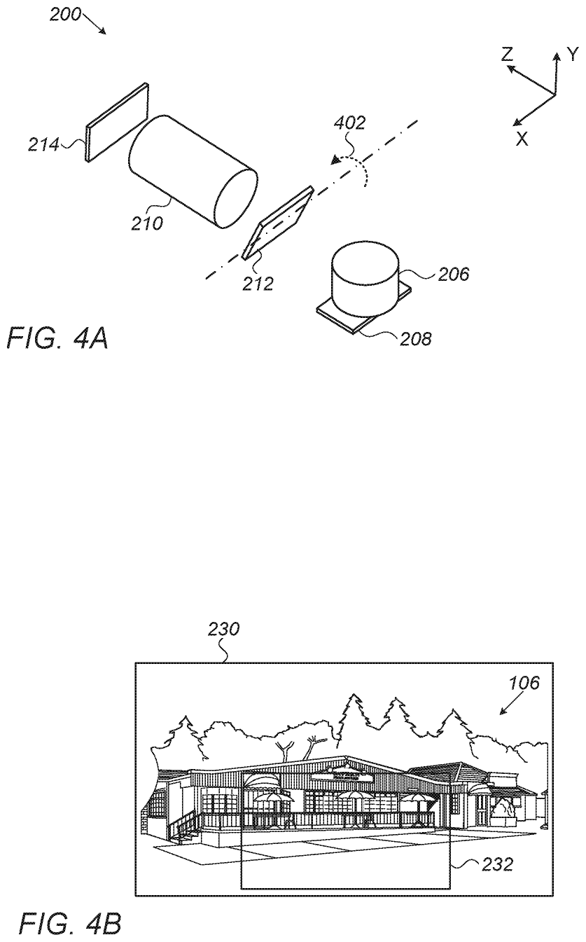

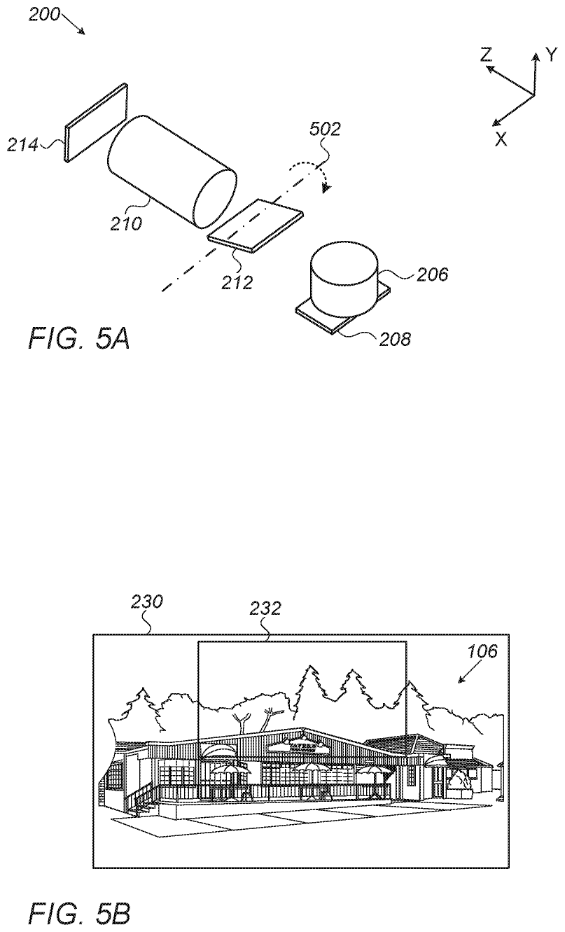

The rotation of prism 212 around the X-axis moves the Tele FOV relative to the Wide FOV, causing other portions of scene 106 to become a “Tele image” with higher resolution. Thus, FIG. 4A shows prism 212 rotated counter-clockwise (as indicated by a curved arrow 402 when viewed in the −X direction) around the X-axis from its zero position to a new, first position. The counter-clockwise rotation causes the Tele FOV, indicated by frame 232, to move to a new, “down” position relative to the Wide FOV indicated by frame 230. FIG. 5A shows prism 212 rotated clockwise (as indicated by a curved arrow 502 when viewed in the −X direction) around the X-axis from its zero position to a new, second position. The clockwise rotation causes the Tele FOV, indicated by frame 232, to move to another new, “up” position relative to the Wide FOV indicated by frame 230. While FIGS. 4A, 4B, 5A and 5B show two discrete prism rotation movements and two discrete Tele FOV positions relative to the Wide FOV, there is clearly an entire range of practically continuous positions that the Tele FOV may occupy, depending on the degree and direction of prism rotation.

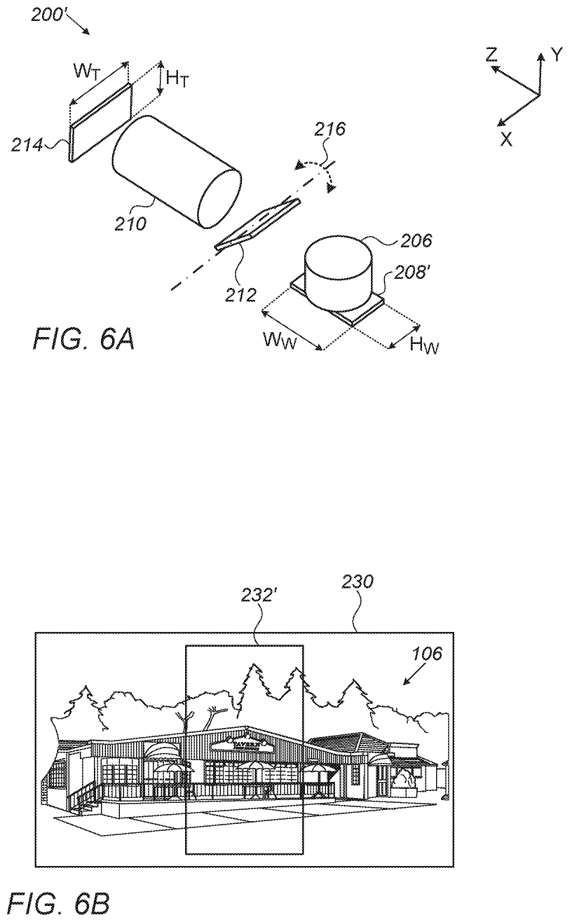

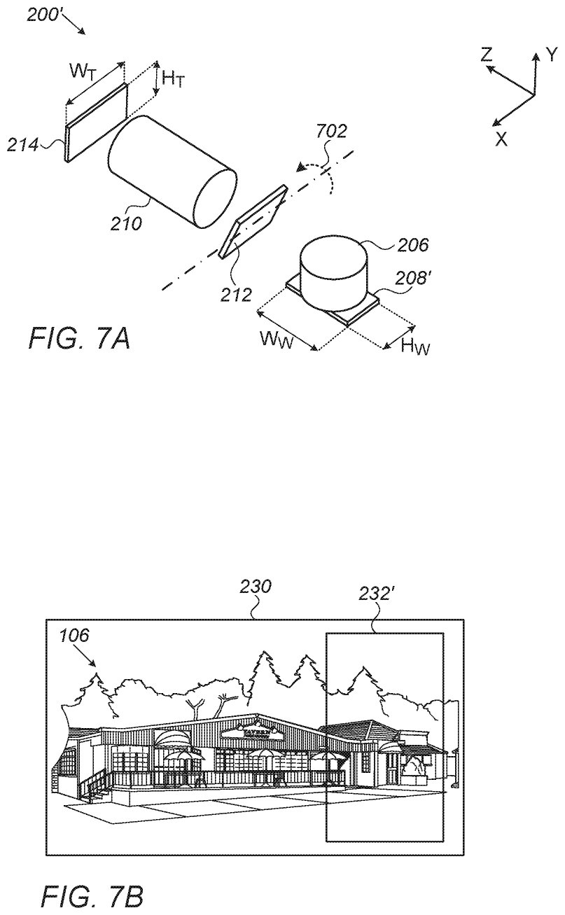

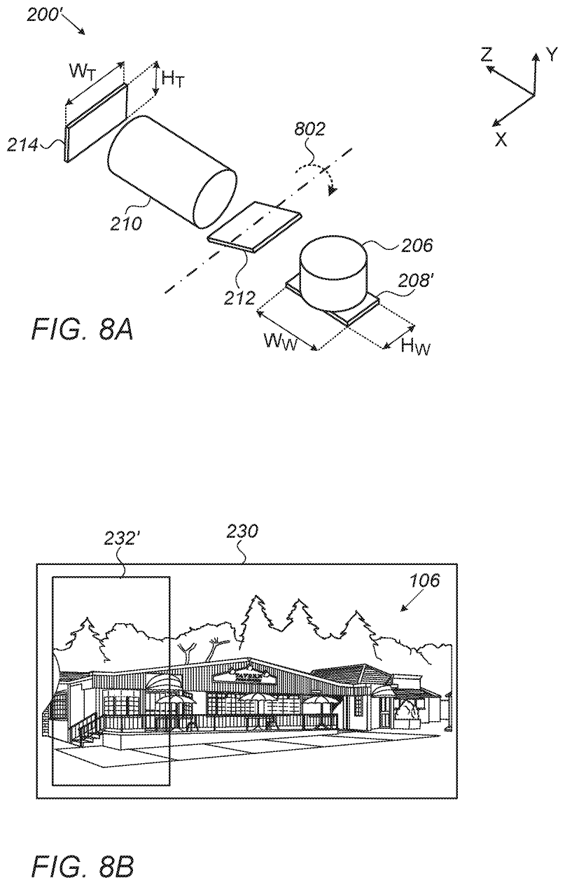

As mentioned, in FIGS. 2A, 3, 4A and 5A, both Wide sensor 208 and Tele sensor 214 are positioned with their longer side (“width”) in the X direction. Their shorter side (“height”) is in the Z direction for sensor 208 and in the Y direction for sensor 214. FIG. 6A shows schematically a dual-aperture camera 200′ comprising an upright camera 206 with a Wide sensor 208′ rotated by 90 degrees relative to sensor 208 in camera 206 of FIG. 2A. As also shown in FIGS. 7A and 8A, Wide sensor 208′ now has its height in the X direction and its width in the Z direction. Note that W_{W} is now also orthogonal to the H_{T}. This 90 degree in-plane rotation of the Wide sensor provides certain advantages in terms of the positioning and movement of FOV_{T} relative to FOV_{W}, and consequently in terms of the capture, processing and display of Tele and Wide images. One major advantage is that a larger percentage of FOV_{W} can have high resolution by setting a prism rotation angle. FIG. 6B shows schematically the position of FOV_{T} 232′ (now rotated by 90 degrees relative to FOV_{W} 230) in a centered position caused by a zero position of prism 212, after the camera itself was rotated by 90 degrees (not shown) compared to the camera of FIG. 2B.

FIG. 7A shows schematically the dual-aperture camera of FIG. 6A with prism 212 rotated counter-clockwise (as indicated by a curved arrow 702 when viewed in the −X direction) around the X-axis from its zero position to a new position. As shown in FIG. 7B, this prism rotation causes Tele FOV 232′ to move to a “right” position relative to the Wide FOV. FIG. 8A shows prism 212 rotated clockwise (as indicated by a curved arrow 802 when viewed in the −X direction) around the X-axis from its zero position to a second position, As shown in FIG. 8B, this prism rotation causes Tele FOV 232′ to move to a “left” position relative to the Wide FOV. While FIGS. 7A, 7B, 8A and 8B show two discrete prism rotation movements and two discrete Tele FOV positions relative to the Wide FOV, there is clearly an entire range of practically continuous positions that the Tele FOV may occupy, depending on the degree and direction of prism rotation.

Note that a similar FOV_{T} relative positioning effect to that described above may be obtained by in-plane rotating Tele sensor 214 by 90 degrees and by leaving Wide sensor 208 unchanged from its original position in FIG. 2A. However, the positioning of sensor 214 with WT in the Y direction may disadvantageously increase a camera height (and therefore a host device thickness).

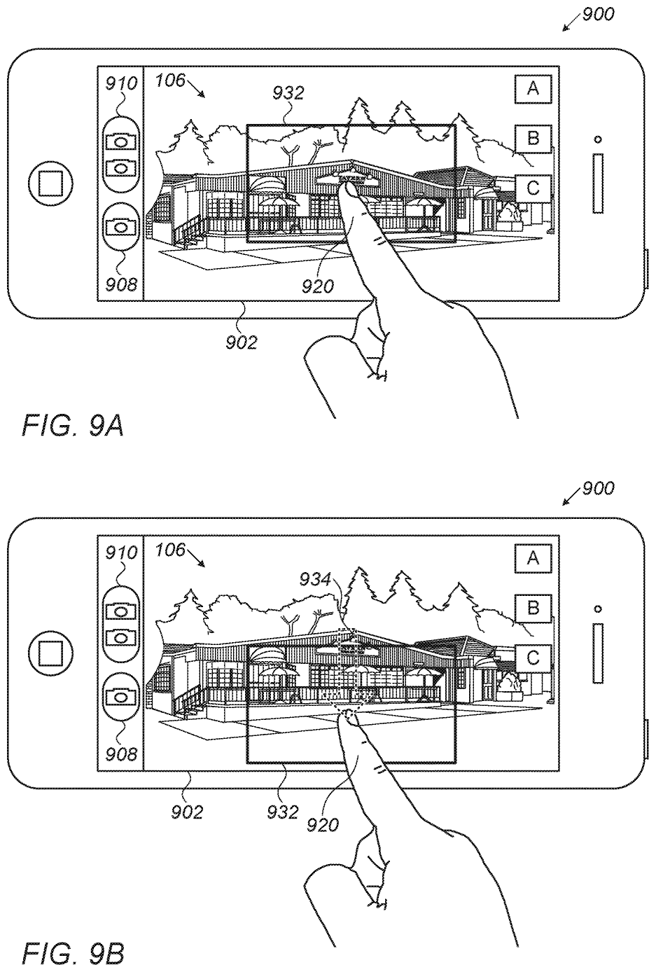

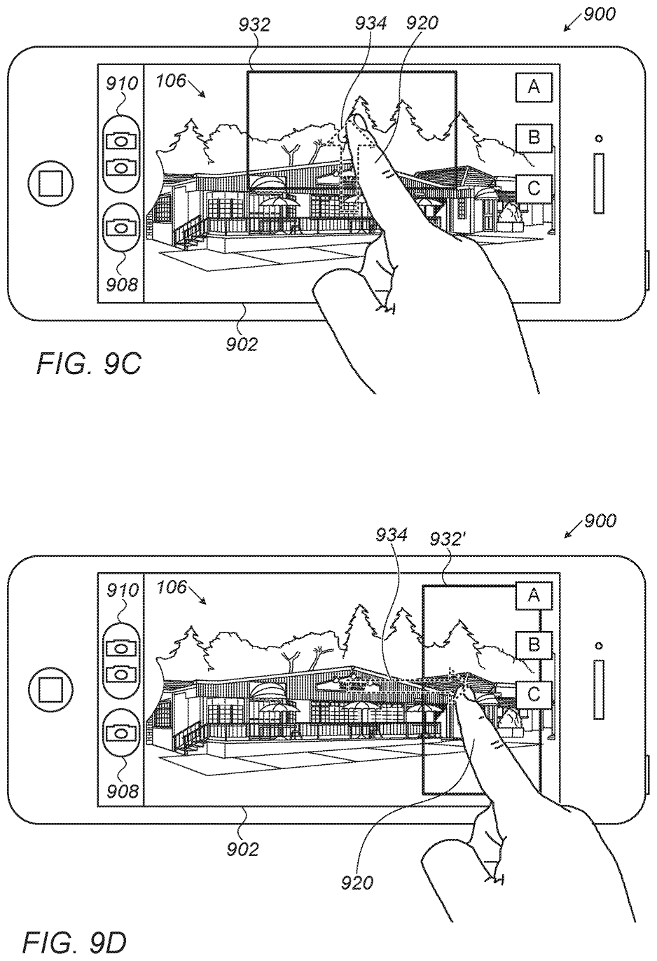

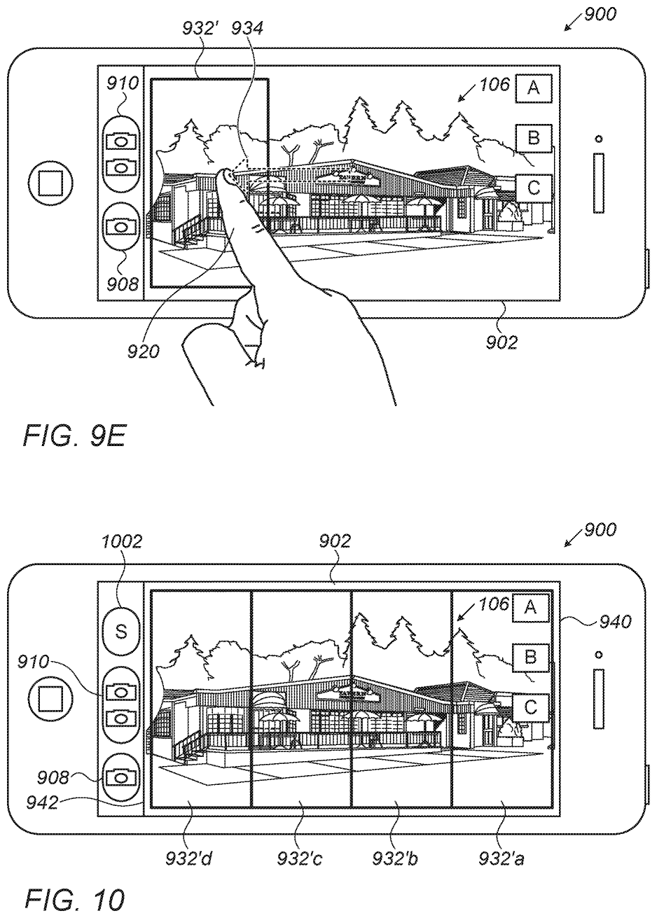

When a dual-aperture camera described above is included for example in a smartphone, the Tele image (i.e. the part of scene 106 viewed and acquired by the Tele camera) is bound by a frame 932 visible on the smartphone screen. FIG. 9A shows an exemplary smartphone 900 that includes on a back side (not shown) a Wide camera and a Tele camera as in FIG. 2A or 6A. The Wide and Tele cameras have known fields of view with a known ratio M=FOV_{T}/FOV_{W} between them. In general, M may have any value between ¼ and ¾. For example, M may have values of ½, 9/16 or ¾. Consequently, frame 932 includes almost exactly the image seen by FOV_{T} and has a size that is a fraction M of the entire screen (which includes the image seen by FOV_{W}). Note that for camera configuration as the one shown in FIG. 6A and for Wide and Tele image sensors with 4:3 aspect ratio, selecting M=¾ will result in FOV_{T} that will overlap the short dimension of FOV_{W} in its entirety and will enable complete scanning of the Wide FOV by tilting the prism. The same argument is applicable for image sensors having 16:9 aspect ratio with M= 9/16.

In still mode, scene 106 is acquired by both cameras, with the Wide camera providing the entire image seen (i.e. the Wide image) and the Tele camera providing the part of scene 106 bound by frame 932. Smartphone 900 further includes, on a front side opposite to the back side, a screen or display 902 displaying a view of scene 106. Screen 902 may display icons or text “A”, “B”, “C”, etc., that provide indications and/or are selectable to perform various operations of the phone and/or the cameras. Such icons or text may be indicative of flash setting, video or stills selection, back or front camera selection, etc. The square boxes surrounding “A”, “B” and “C” are merely illustrative and may have different shape or be removed altogether in some cases. Note that the fact that only three icons are shown is not meant to be limiting, and that more or fewer icons may be displayed and/or selectable at any time during or prior to image acquisition by the cameras and/or during display of acquired images. In an embodiment of the dual-aperture camera as in FIG. 2A, the “zero” position of the prism provides the composite image seen in FIG. 9A, where frame 932 is centered on the screen.

In various embodiments and as described in more detail in PCT/IB2016/056060, smartphone 900 may have a user interface that includes a single camera icon (or “button”) 908 and a “two-camera” button 910. The two-camera button may appear on the screen when the FOV of the scene (FOV_{scene}) is greater or equal to FOV_{T}. As described in detail in PCT/IB2016/056060, the user interface displays visually the almost exact FOV_{T} and enables simple acquisition of the image within FOV_{T}, thereby providing a Tele image with the highest resolution enabled by the Tele camera. The user interface also enables simultaneous acquisition (with a single input through the user interface, i.e. using two-camera button 910) of a Wide image and a Tele image. Image fusion of the Wide and Tele images or video streams can take place on the capturing device or in a cloud environment.

The present inventors have determined that, advantageously, a user interface as described above can be used to “drag” frame 932 (and FOV_{T}) on screen 902 to bring different parts of the scene into FOV_{T}. That is, the dragging of frame 932 is translated into rotation of the “folded” path prism, such that the higher resolution Tele image “moves” to different parts of the scene. The dragging may be performed by a firm touch of the screen by a finger 920 and movement of the finger across the screen. In FIG. 9A, the finger touches the screen in the general area of “zero” positioned (centered) frame 932. The finger may drag the frame (and FOV_{T}) to a “down” position as in FIG. 9B, to an “up” position as in FIG. 9C, or to any intermediate position (not shown) between the down and up positions. The touch and drag actions are relayed to a camera controller (not shown), which, in turn, controls the prism movement. The dragging of frame 932 to the down position in FIG. 9B, indicated schematically by an arrow 934, is equivalent to rotation of the prism to its position in FIG. 4A. The dragging of frame 932 to the up position in FIG. 9C is equivalent to rotation of the prism to its position in FIG. 5A. Similarly, with a dual-aperture camera with a 90 degree rotated Wide sensor as in FIGS. 6A-8A, a frame 932′ (now also rotated by 90 degrees relative to frame 932 in FIGS. 9A-9C) may be dragged from a zero position to a “right” position as in FIG. 9D or a “left” position as in FIG. 9E. The dragging of frame 932′ to the right position in FIG. 9D is equivalent to rotation of the prism to its position in FIG. 7A. The dragging of frame 932′ to the up position in FIG. 9E is equivalent to rotation of the prism to its position in FIG. 8A.

As described in detail in PCT/IB2016/056060, in terms of image acquisition, a user may press two-camera button 910 to simultaneously acquire two images, the Wide image of scene 106 at its respective (lower) image resolution and the Tele image of region (frame) 932 (or 932′) at its respective (higher) image resolution. The two images may be stored in an on-board storage (such as “camera roll” in an iPhone) and may be displayed or downloaded for further use as known in the art. The user may press single camera button 908 to acquire only the Wide image, which can further be stored, displayed and downloaded for further use. The user may choose for display on screen 902 only the Tele image by, for example, double-tapping or pressing at any point on the screen within frame 932 (or 932′). This action leads to display of the Tele image on the entire screen. The Tele image (only) can then be chosen for acquisition by pressing on single camera button 908. The acquired Tele image can then be stored, displayed and downloaded for further use as above. The two images can also be fused (on the camera hosting device or in a cloud) into a composite image with a portion marked by a frame 932 or 932′ formed by the higher-resolution Tele image, and with a peripheral portion formed by a peripheral portion of the relatively lower resolution Wide image.

Clearly, frame 932′ (and the Tele FOV) may be dragged to any intermediate position (not shown) between the right and left positions. In other words, the Tele FOV may be moved laterally on the screen to a number of partially overlapping or non-overlapping (but touching) positions, from a right-most position (at a right screen edge 940) to a left-most position (at a left screen edge 942) or vice-versa, and an entire image of the scene may be “stitched” together from the partially overlapping or non-overlapping Tele images. For example, as shown in FIG. 10, the ratio M of the Tele and Wide FOVs may be such that screen 902 includes, and is substantially covered by, four adjacent frames 932′a-d. Note that the screen may include fewer adjacent frames than the number required to substantially fill in the entire screen. For example, in an embodiment, there may be only two or three adjacent frames (instead of the four shown). An optional “Scan” icon or button 1002 may then be used to scan (i.e. move the FOV_{T} frame) automatically from a right-most position on the screen (i.e. from frame 932′a) to a left-most position (i.e. to frame 932′d) or vice-versa. Alternatively, a “Scan” command may be given by voice control. The scan function, similarly to the dragging action, provides partially overlapping or non-overlapping Tele images that can be stitched together into a high-resolution Tele image of the entire scene. A scan command, whether through icon 1002 or vocally, may also lead to acquisition of each Tele image defined by a frame 932′ and to its storage for further processing. A Wide image can be captured during the scan function, allowing further processing that may include image fusion of the Wide image with the various Tele images (or the stitched Tele images) to form a high resolution image with a FOV that is larger than FOV_{T}.

Note that the direction of prism rotation and the consequent movement of FOV_{T} relative to FOV_{W} on a smartphone (or any other host device) screen depends on the geometry of the assembly of the dual-aperture camera in the host device. The description above relates to one particular such geometry. In a different geometry, the prism rotation directions and the resulting FOV_{T} movement may be in opposite directions to those described above.

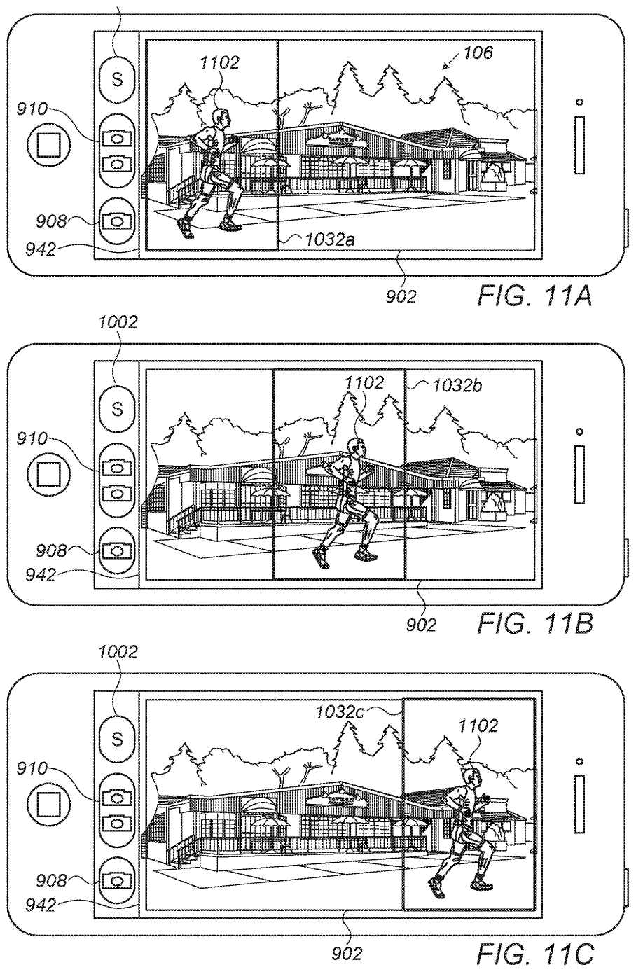

The devices, used interface and associated methods disclosed above may be used for automatic movement or “automatic adjustment” of the Tele FOV for e.g. tracking a subject in an autonomous manner. We refer to a camera mode that performs automatic Tele FOV movement to track an object or subject of interest as “autonomous Tele FOV tracking”. The autonomous Tele FOV movement is in response to recognition (through e.g. the smart-phone camera) of the object or subject of interest, and the Tele image focuses on and displays the object or subject of interest. The object recognition may be performed using any of the methods known in the art. An example of autonomous Tele FOV tracking is shown in FIGS. 11A-11C.

FIG. 11A shows a smartphone and user interface incorporating a dual-aperture camera with automatic Tele FOV tracking disclosed herein with a first Tele FOV position on the smartphone screen. FIG. 11B shows the smartphone and user interface of FIG. 11A with a second Tele FOV position on the smartphone screen. FIG. 11C shows the smartphone and user interface of FIG. 11A with a third Tele FOV position on the smartphone screen. In each of these figures, the object of interest is a runner 1102. The decision to track the runner is taken either by the user (e.g., by touching the runner's image) or automatically (e.g., using face detection). It is assumed that the Tele camera can change its FOV by tilting the prism to track the object of interest. Ideally, the camera will track the object such that it is as close as possible to the center of the adjustable Tele FOV as seen in 1032a, 1032b and 1032c.

While the smartphone shown in FIGS. 11A-11C displays icons 908, 910 and 1002, one or more other icons (not shown) may replace and/or be used in addition to or instead of icons 908, 910 and 1002 during operation in the Tele FOV tracking mode.

Wide and Tele images and/or video streams can be recorded during the automatic tracking mode and fused together to form a composite image or composite video stream. This fusion can be applied on the camera hosting device or alternatively, Wide and Tele images or video streams can be uploaded to the cloud for applying this fusion operation. Each composite image may also be formed with FOV_{W} by scanning with the Tele camera, stitching a plurality of Tele images to provide a “stitched” Tele image, then fusing the stitched Tele image with the Wide image. This is advantageous in that the Wide image captures the entire scene simultaneously, while the Tele images to be stitched together are consecutive, so one can overcome motion or occlusions in the scene if required. The stitching of the Tele images and/or the fusion of the stitched Tele image with the Wide image may also be performed in a cloud.

While this disclosure has been described in terms of certain embodiments and generally associated methods, alterations and permutations of the embodiments and methods will be apparent to those skilled in the art. The disclosure is to be understood as not limited by the specific embodiments described herein, but only by the scope of the appended claims.

What is claimed is:

1. A mobile device, comprising:
a camera operational to capture a first video stream of first images and a second video stream of second images, the first images having a first field-of-view (FOV1) and a first spatial resolution and the second images having a second FOV2<FOV1 and a second spatial resolution higher than the first spatial resolution;
a camera controller configured to move FOV2 relative to FOV1, causing other portions of a scene to become a second image;
a screen; and
a user interface (UI) for operating the camera,
wherein the UI is configured to display a respective video including frames from the first video stream and/or the second video stream,
and wherein a frame visible on the screen shows FOV2 within FOV1.

2. The mobile device of claim 1, wherein the frame visible on the screen defines FOV2 within FOV1.

3. The mobile device of claim 1, wherein the UI is configured to display at least one icon and an image of the object or the scene acquired with at least one of the first video stream and the second video stream.

4. The mobile device of claim 1, wherein the UI further comprises means for moving FOV2 relative to FOV1.

5. The mobile device of claim 4, wherein the means for moving FOV2 relative to FOV1 comprise a firm touch of the screen by a finger or a movement of a finger across the screen.

6. The mobile device of claim 1, wherein the UI further comprises means for switching the screen from displaying the first images to displaying the second images.

7. The mobile device of claim 1, wherein the UI further comprises means to acquire a second image.

8. The mobile device of claim 1, wherein the UI further comprises means to simultaneously acquire a first image and a second image.

9. The mobile device of claim 1, wherein the user interface comprises means to autonomously move FOV2 relative to FOV1 to track an object of interest.

10. The mobile device of claim 9, wherein the camera controller is configured to receive data about the object from the first images for tracking the object with FOV2 autonomously.

11. The mobile device of claim 9, wherein the camera controller is configured to use face detection to decide whether to track an object with FOV2 autonomously.

12. The mobile device of claim 9, wherein the autonomous tracking of the object with FOV2 autonomously is done such that the object is as close as possible to a center of the moved FOV2.

13. The mobile device of claim 1, wherein the camera controller is configured to record a first image and a second image during the FOV2 moving and to fuse the first image and the second image to form a composite image.

14. The mobile device of claim 1, wherein the camera controller is configured to record the first video stream and the second video stream during the autonomous FOV2 tracking and to fuse first images and second images to obtain a composite video stream.

15. The mobile device of claim 1, wherein the camera controller is configured to capture a first image and a plurality of second images during the FOV2 moving and to fuse the first image and the plurality of second images to form a composite image, wherein the first image captures an entire scene simultaneously and wherein the plurality of second images captures parts of the entire scene consecutively.

16. The mobile device of claim 1, wherein in a still mode the camera controller is configured to acquire a scene by both video streams simultaneously, and wherein first images provide an entire scene and second images provide a part of the scene.

17. The mobile device of claim 1, wherein the camera is a dual-camera, and wherein the first video stream of images is captured by a first camera and the second video stream of images is captured by a second camera.

18. The mobile device of claim 17, wherein the first camera is an upright camera.

19. The mobile device of claim 17, wherein the second camera is a folded camera comprising an optical path folding element.

20. The mobile device of claim 1, wherein the mobile device is a smartphone.
